(19) United States
(12) Patent Application Publication
(10) Pub. No.: US 2026/0162675 A1
(43) Pub. Date: Jun. 11, 2026

(54) ACTUATOR ASSEMBLY AND MAGNETIC DISK DEVICE

(71) Applicants: Kabushiki Kaisha Toshiba, Tokyo (JP); Toshiba Electronic Devices & Storage Corporation, Tokyo (JP)

(72) Inventors: Kenichiro AOKI, Machida Tokyo (JP); Yasutaka SASAKI, Nakano Tokyo (JP)

(21) Appl. No.: 19/178,755

(22) Filed: Apr. 14, 2025

(30) Foreign Application Priority Data
Dec. 10, 2024 (JP) 2024-215414

(51) Int. Cl. G11B 5/48

(52) U.S. Cl. CPC G11B 5/4873; G11B 5/483; G11B 5/4833

(57) ABSTRACT

According to one embodiment, an actuator assembly includes a first head suspension assembly including a suspension and a piezoelectric element mounted on and bonded to the suspension by a first conductive adhesive applied to a second surface of the suspension, and a second head suspension assembly including a suspension and a piezoelectric element mounted on and bonded to the suspension by a second conductive adhesive applied to a second surface of the suspension. The first and second suspension assemblies are arranged such that the second surfaces of the suspensions oppose each other and the piezoelectric elements oppose each other. A top portion of the first conductive adhesive is offset in a planar direction of the suspension with respect to a top portion of the second conductive adhesive.

### CROSS-REFERENCE TO RELATED APPLICATIONS

This application is based upon and claims the benefit of priority from Japanese Patent Application No. 2024-215414, filed December 10, 2024, the entire contents of which are incorporated herein by reference.

### FIELD

Embodiments described herein relate generally to an actuator assembly and a magnetic disk device with the same.

### BACKGROUND

As a magnetic disk device, for example, a hard disk drive (HDD) comprises a plurality of magnetic disks arranged to be rotatable in a housing, a plurality of magnetic heads that read and write information to and from the magnetic disks, and a head actuator (actuator assembly) that supports the magnetic heads to be movable with respect to the magnetic disks.

The head actuator includes an actuator block supported to be rotatable, and a plurality of head suspension assemblies (, which may as well be referred to as head gimbal assemblies) each extending from the actuator block and supporting the magnetic heads, respectively, at their distal end portions. The head suspension assembly includes a base plate having one end fixed to an arm, a load beam extending from the base plate, a tub extending from a tip of the load beam, and a flexure (wiring member) provided on the load beam and base plate. The flexure includes a gimbal portion that can be freely displaced, and a magnetic head is mounted on the gimbal portion.

Further, recently, for example, such a configuration has been proposed, in which a plurality of, for example, two piezoelectric elements are mounted on a suspension assembly and the elements are utilized as a micro actuator. Here, each of the piezoelectric elements is electrically connected to the base plate or load beam by a conductive adhesive or the like.

When a plurality of suspension assemblies having the above-described configuration are attached to an actuator arm so as to be stacked in layers, the portions applied with the conductive adhesive described above are disposed in a state where they oppose each other in each adjacent pair of the suspension assemblies. As a result of this structure, when a plurality of suspension assemblies are stacked in layers on actuator arms, the base plate or load beam will deform elastically, which creates a possibility that the conductive adhesives of adjacent suspension assemblies will interfere with each other, that is, come into contact with each other. Particularly, in magnetic disk drives that have a large number of magnetic disks, the arm is formed thin, and the suspension assembly itself is also formed thin. With such a structure, the above-described conductive adhesives are more likely to come into contact with each other.

### BRIEF DESCRIPTION OF THE DRAWINGS

FIG. 1 is an exploded perspective view showing a base and a top cover of a hard disk drive (HDD) according to the first embodiment.

FIG. 2 is a perspective view showing a head actuator of the HDD and an FPC unit.

FIG. 3 is a side view schematically showing the head actuator.

FIG. 4 is a perspective view showing an up-head suspension assembly of the head actuator.

FIG. 5 is a plan view showing a magnetic head side of the up-head suspension assembly.

FIG. 6 is a plan view showing a surface (rear surface) on an opposite side to the magnetic head of the up-head suspension assembly.

FIG. 7 is a cross-sectional view showing a piezoelectric element portion taken along line A-A of FIG. 5.

FIG. 8 is a plan view showing a surface on a magnetic head side of a down-head suspension assembly.

FIG. 9 is a plan view schematically showing the up-head suspension assembly and down-head suspension assembly disposed in a stacked state.

FIG. 10 is a surface (rear surface) on an opposite side to a magnetic head of an up-head suspension assembly in a hard disk drive (HDD) of the second embodiment.

FIG. 11 is a surface (rear surface) on an opposite side to a magnetic head of a down-head suspension assembly in the hard disk drive (HDD) of the second embodiment.

FIG. 12 is a side view schematically showing a portion of an actuator assembly in an HDD of the third embodiment.

### DETAILED DESCRIPTION

Various embodiments will be described hereinafter with reference to the accompanying drawings. In general, according to one embodiment, an actuator assembly comprises a first head suspension assembly comprising a suspension including a first surface, a second surface on an opposite side and a center axis, a wiring member and a magnetic head which are mounted on the first surface of the suspension, and a piezoelectric element mounted on the suspension and bonded to the suspension by a first conductive adhesive applied to a side of the second surface; and a second head suspension assembly comprising a suspension including a first surface, a second surface on an opposite side, and a center axis, a wiring member and a magnetic head which are mounted on the first surface of the suspension, and a piezoelectric element mounted on the suspension and bonded to the suspension by a second conductive adhesive applied to a side of the second surface. The first head suspension assembly and the second head suspension assembly are arranged in such a manner that the second surfaces of the suspensions oppose each other and the piezoelectric elements oppose each other, and a top portion of the first conductive adhesive is located to be offset in a planar direction of the suspension with respect to a top portion of the second conductive adhesive.

Note that the disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings show schematic illustration rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

### First Embodiment

As a magnetic disk device, a hard disk drive (HDD) according to the first embodiment will be described.

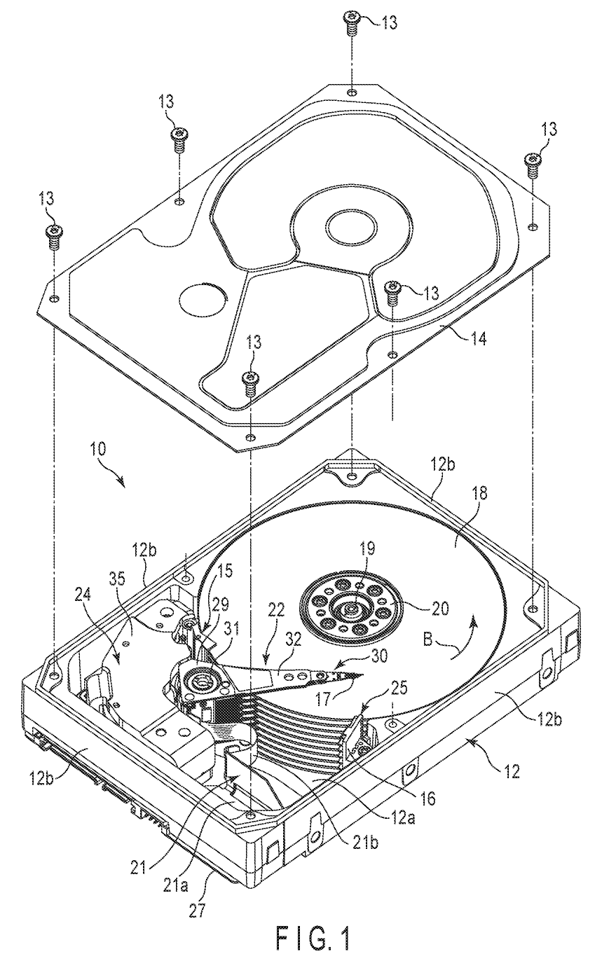

FIG. 1 is an exploded perspective view of the HDD of the first embodiment when a cover thereof is removed.

As shown in the figure, the HDD comprises a rectangular-shaped housing 10. The housing 10 includes a rectangular box-shaped base 12 whose upper surface is open, and a cover (top cover) 14. The base 12 includes a rectangular bottom wall 12a and side walls 12b each standing along a respective edge of the bottom wall 12a, and is molded to be integrated as one body from, for example, aluminum. The cover 14 is formed into a rectangular plate shape, for example, of stainless steel. The cover 14 is screwed onto the side walls 12b of the base 12 with a plurality of screws 13 to airtightly close the opening of the upper portion of the base 12.

In the housing 10, there are a plurality of, for example, ten magnetic disks 18 as disk-shaped recording media and a spindle motor 19 that supports and rotates the magnetic disks 18. The spindle motor 19 is disposed on the bottom wall 12a. Each magnetic disk 18 includes a substrate formed as a round disk having a diameter of, for example, 96 mm (3.5 inches), made of a non-magnetic material, for example, glass, and magnetic recording layers formed on upper and lower surfaces of the substrate. The magnetic disks 18 are fitted to a hub of the spindle motor 19 so as to be coaxial with respect to each other and are further clamped by a clamping spring 20. With this structure, the magnetic disks 18 are supported in a state that they are positioned parallel to each other at predetermined intervals and substantially parallel to the bottom wall 12a. These magnetic disks 18 are rotated by the spindle motor 19 at a predetermined speed in a direction indicated by an arrow B. Note that the number of magnetic disks 18 mounted is not limited to ten, but may be nine or less, or ten or more

In the housing 10, there are a plurality of magnetic heads 17 that write and read information with respect to the magnetic disks 18, and an actuator assembly 22 that supports these magnetic heads 17 in a movable manner with respect to the magnetic disks 18, respectively. Further, in the housing 10, there are provided a voice coil motor (VCM) 24 that pivots and positions the actuator assembly 22, a ramp load mechanism 25 that holds a magnetic heads 17 in an unload position away from the respective magnetic disk 18 when the magnetic head 17 moves to the outermost circumference of the respective magnetic disk 18, a substrate board unit (FPC unit) 21 on which electronic components such as conversion connectors and the like are mounted, and a spoiler 15. The VCM 24 includes a pair of yokes 35 provided on the bottom wall 12a and magnets not shown that are fixed to the yokes 35. The ramp load mechanism 25 includes a ramp 16 formed to stand on the bottom wall 12a.

To an outer surface of the bottom wall 12a of the base 12, a printed circuit board 27 is screwed. The printed circuit board 27 is configured as a control unit that controls the operation of the spindle motor 19 and also controls the operation of the VCM 24 and the magnetic heads 17 via the substrate board unit 21.

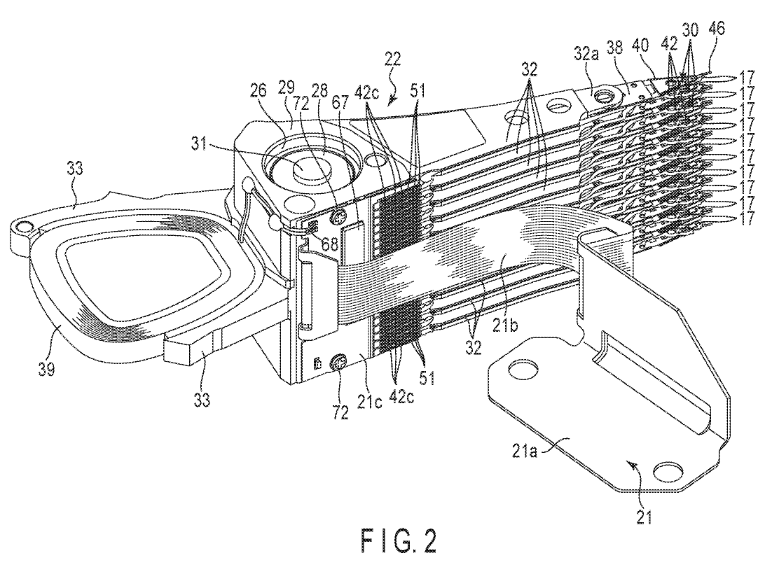

FIG. 2 is a perspective view of the actuator assembly. As shown in FIG. 2, the actuator assembly 22 includes an actuator block 29 having a through hole 26, a bearing unit (unit bearing) 28 provided in the through hole 26, a plurality of, for example, eleven arms 32 extending from the actuator block 29, a head suspension assembly (head gimbal assembly, which may be referred to as HGA in some cases) 30 attached to each of the arms 32, and a magnetic head 17 supported by each of the head suspension assemblies 30. On the bottom wall 12a of the base 12, a support shaft (pivot shaft) 31 is provided to stand upright. The actuator block 29 is supported by the bearing unit 28 so as to be rotatable around the support shaft 31.

In this embodiment, the actuator block 29 and the eleven arms 32 are molded to be integrated as one body from aluminum or the like to form a so-called E-block. The arms 32 are, for example, formed as elongated flat plates and extend from the actuator block 29 in a direction perpendicular to the support shaft 31. The eleven arms 32 are provided in parallel with each other at intervals therebetween.

The actuator assembly 22 includes a support frame 33 that extends from the actuator block 29 in a direction opposite to the arms 32, and the voice coil 39, which constitutes a part of the VCM 24, is supported by the support frame 33. As shown in FIG. 1, the voice coil 39 is located between a pair of yokes 35, one of which is fixed to the base 12, and these yokes 37, together with the magnet fixed to any one of the yokes, constitute the VCM 24.

As shown in FIG. 2, the actuator assembly 22 comprises twenty head suspension assemblies 30, each of which supports a respective magnetic head 17. The head suspension assemblies 30 are attached to distal end portions 32a of the respective arms 32. The plurality of head suspension assemblies 30 include up-head suspension assemblies (30u) that support the magnetic heads 17 so as to face upward (, which may in some cases be referred to as first head suspension assemblies) and down-head suspension assemblies (30d) that support the magnetic heads 17 so as to face downward (, which may in some cases be referred to as second head suspension assemblies). The up-head suspension assemblies (30u) and the down-head suspension assemblies (30d) are configured by arranging the head suspension assemblies 30 of the same structure in up and down directions, respectively. Note here that as to the direction of extension of the flexure 42, which will be described later, the up-head suspension assemblies (30u) and the down-head suspension assemblies (30d) are opposite to each other, and the up-head suspension assemblies and the down-head suspension assemblies are arranged in a reversed state and stacked on one side to the other, thereby matching them in terms of the direction of extension of the flexure.

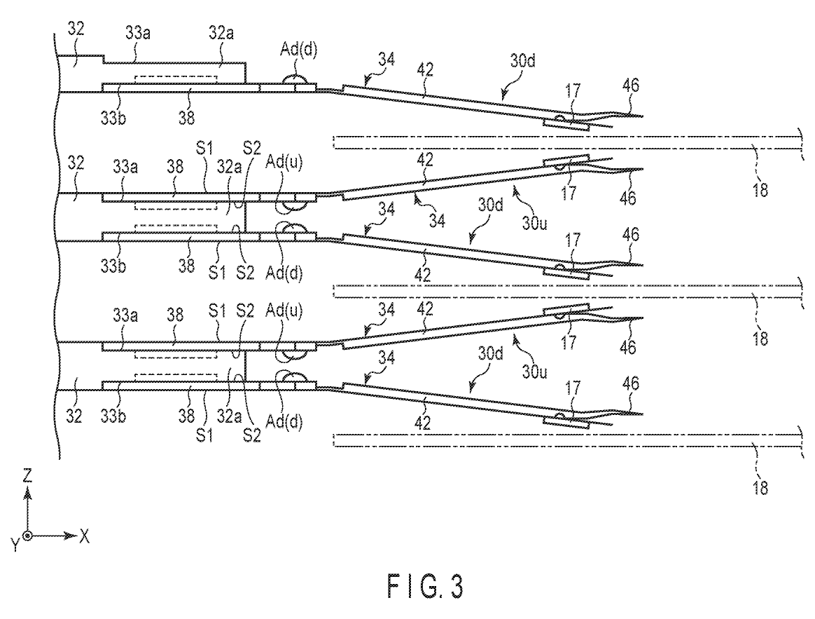

FIG. 3 is a side view schematically showing multiple head suspension assemblies 30. In this embodiment, each arm 32 includes a first seating surface 33a formed at the distal end portion 32a and a second seating surface 33b opposing the first seating surface. The down-head suspension assembly 30d is attached to the second seating surface 33b of the uppermost arm 32, and the up-head suspension assembly 30u is attached to the first seating surface 33a of the lowermost arm 32. The up-head suspension assembly 30u and down-head suspension assembly 30d are attached to the first seating surface 33a and second seating surface 33b, respectively, in each of the nine intermediate arms 32.

The head suspension assemblies 30 each include a base plate 38 of substantially a rectangular shape, a load beam 40 made from an elongated plate spring, and a slender strip-shaped flexure (wiring member) 42. The flexure 42 has a gimbal portion, which will be described later, and the magnetic head 17 is placed on the gimbal portion. The base plate 38 has a proximal portion that is fixed to the distal end portion 32a of the arm 32, for example, by caulking. The load beam 40 has a proximal end portion that overlaps and is fixed to the end portion of the base plate 38. The load beam 40 is formed to extend from the base plate 38 and taper down towards the extending end thereof.

The base plate 38 and the load beam 40 constitute a support plate, that is, a suspension 34. From the tip of the load beam 40, a tab 46 protrudes. The tab 46 can engage with the ramp 16 described above, and together with the ramp 16, constitutes a ramp load mechanism 25.

As shown in FIG. 2, the FPC unit 21 includes a substantially rectangular base portion 21a bent into an L shape, a slender strip-shaped relay portion 21b extending from one side edge of the base portion 21a, and a joint portion 21c provided continuously at the tip of the relay portion 21b. The base portion 21a, relay portion 21b, and joint portion 21c are formed using a flexible printed circuit board (FPC). The flexible printed circuit board includes an insulating layer such as of polyimide, a conductive layer provided on this insulating layer and forming multiple wiring lines, connection pads and the like, and a protective layer covering the conductive layer.

On the base portion 21a, electronic components such as conversion connectors and multiple capacitors and the like, not shown in the figure, are mounted and electrically connected to the wiring lines not shown. The base portion 21a is installed on the bottom wall 12a of the base 12. The relay portion 21b extends from the side edge of the base portion 21a toward the actuator block 29 of the actuator assembly 22. The junction portion 21c provided at the extending end of the relay portion 21b is formed into a rectangular shape having a height and a width that are substantially equal to those of the side surface (installation surface) of the actuator block 29. The junction portion 21c is attached to the installation surface of the actuator block 29 via a lining plate made of aluminum or the like, and is further fixed to the installation surface by means of fixing screws 72. A large number of connection pads are provided on the junction portion 21c. For example, one head IC (head amplifier) 67 is mounted on the joint portion 21c, and this head IC 67 is connected to the connection pad and base portion 21a via a wiring line. Further, the joint portion 21c is provided with a connection terminal 68 to which the voice coil 39 is connected.

The flexure 42 of each head suspension assembly 30 includes one end portion electrically connected to the respective magnetic head 17, an other end portion that extends to the actuator block 29 through a groove formed in a side edge of the respective arm 32, and a connection end portion (tail connection terminal portion) 42c formed at the other end portion. The connection end portion 42c is formed into a slender rectangular shape. The connection end portion 42c is provided with a plurality of, for example, thirteen connection terminals (connection pads) 51. These connection terminals 51 are each connected to the wiring lines of the respective flexure 42. That is, the wiring lines of the flexure 42 extend over substantially the entire length of the flexure 42, and one end is electrically connected to the respective magnetic head 17, whereas the other end is connected to the connection terminal (connection pad) 51.

The connection terminals 51 provided at the respective connection ends 42c of the twenty flexures 42 are bonded to the connection pads of the junction portions 21c, and are electrically connected to the wiring lines of the junction portions 21c via the connection pads. With this configuration, the twenty magnetic heads 17 of the actuator assembly 22 are electrically connected to the base portion 21a via the wiring lines of the flexures 42, the connection end portions 42c, the joint portion 21c of the FPC unit 21, and the relay portion 21b, respectively.

When the actuator assembly 22 configured as described above is assembled on the base 12, the support shaft 31 is set to stand substantially parallel to the spindle of the spindle motor 19. Each magnetic disk 18 is positioned between two adjacent head suspension assemblies 30. When the HDD is operating, the magnetic heads 17 respectively supported by the two head suspension assemblies 30 are placed to oppose the upper and lower surfaces of the respective magnetic disk 18, respectively.

Next, the configuration of the head suspension assembly 30 will be explained in detail.

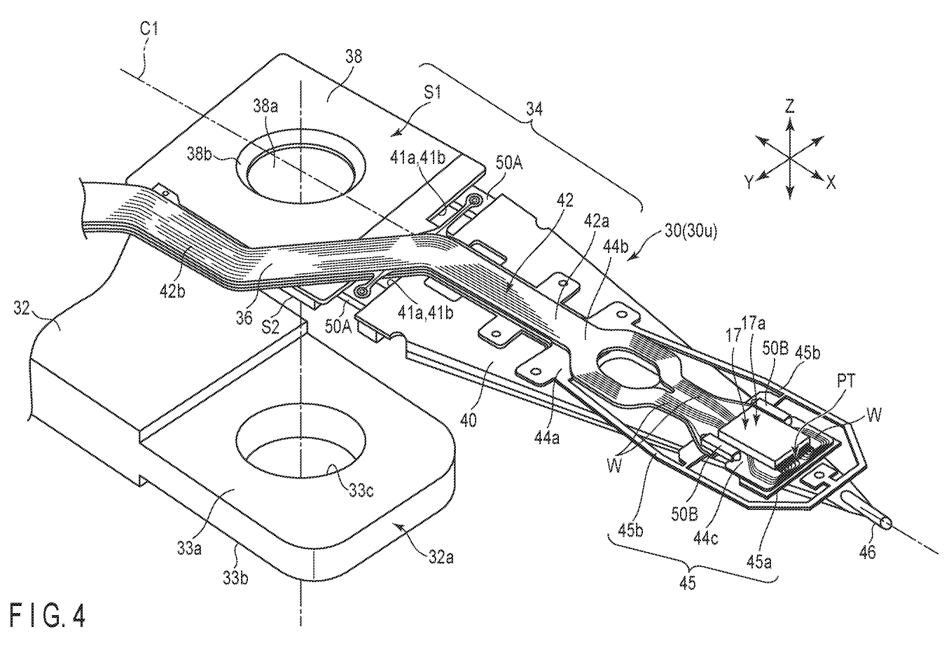

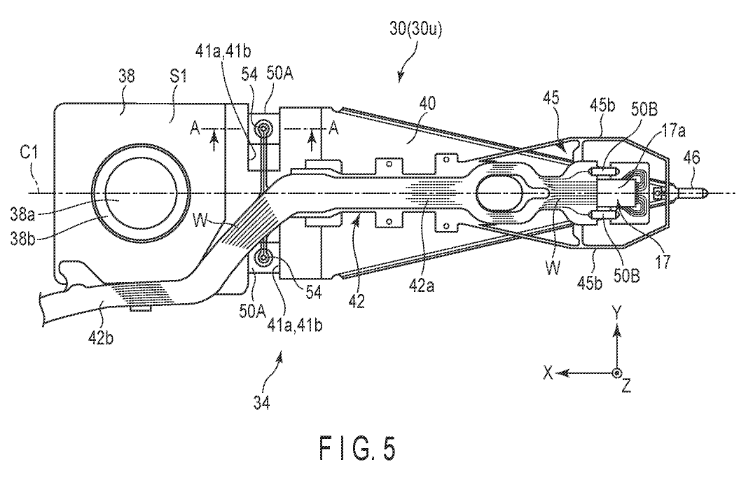

FIG. 4 is a perspective view showing a magnetic head side of an up-head suspension assembly, and FIG. 5 is a plan view showing a magnetic head side of an up-head suspension assembly.

As shown in FIGS. 4 and 5, the head suspension assemblies 30 each include a suspension 34 that functions as a support plate. The suspension 34 include a rectangular-shaped base plate 38 made of a metal plate having a thickness of several hundred micrometers and a slender leaf-spring-like load beam 40 made of a metal plate having a thickness of several tens of micrometers. In one example, the base plate 38 is formed to have a thickness of about 150 to 200 μm, and the load beam 40 is formed to have a thickness of about 25 to 30 μm. The base plate 38 and load beam 40 are formed, for example, from stainless steel. Here, the top surface of the suspension 34 is defined as a first surface S1, and the rear surface of the suspension 34 is defined as a second surface S2.

The load beam 40 has a proximal end portion arranged to overlap the tip portion of the base plate 38, and is fixed to the base plate 38 by welding at multiple locations. The proximal end portion of the load beam 40 is formed to have a width approximately equal to the width of the base plate 38. The load beam 40 extends from the base plate 38. The load beam 40 is formed to taper down, that is, the width gradually narrows from the proximal end portion to the tip portion. At the tip portion of the load beam 40, a slender rod-shaped tab 46 is formed to protrude therefrom.

The base plate 38 includes a circular through hole (caulking hole) 38a and a circular flange 38b located around the circumference of the through hole 38a. The flange 38b extends into the through hole 38a.

As shown in FIG. 4, the arm 32 includes a flat first seating surface 33a and a second seating surface 33b formed on the distal end portion 32a, and a circular caulking hole 33c formed through the seating surfaces 33a and 33b. The first seating surface 33a and the second seating surface 33b oppose mutually parallel to each other. The second surface S2 of the base plate 38 is placed on the first seating surface 33a, and the flange 38b is fitted into the caulking hole 33c. By caulking this flange 38b, the base plate 38 is secured to the distal end portion 32a of the arm 32. Note that the base plate 38 may as well be secured to the distal end portion 32a of the arm 32 by laser welding, spot welding, or bonding.

As shown in FIGS. 4 and 5, the head suspension assembly 30 has a center axis C1 passing through the center of the through hole 38a and the tab 46. The load beam 40 extends from the base plate 38 along the center axis C1. Here, the direction of extension of the center axis C1 is defined as a first direction (longitudinal direction) X of the suspension assembly, and the direction that is perpendicular to the first direction X is defined as a second direction (width direction) Y. The direction that is perpendicular to the first direction X and the second direction Y is defined as a third direction (height direction) Z. Further, the direction parallel to the X-Y plane may be in some cases referred to as a planar direction.

In the region where the base plate 38 and the load beam 40 overlap each other, a pair of rectangular apertures (notches) 41a are formed at the distal end portion of the base plate 38, each of which functions as a mounting portion. Further, a pair of rectangular apertures (notches) 41b are formed at the proximal end portion of the load beam 40, each of which functions as a mounting portion. Each of the apertures 41a and 41b is open on both sides of each of the base plate 38 and the load beam 40. Each of the apertures 41a and 41b extends in the second direction Y and is open on a side edge of the base plate 38 and a side edge of the load beam 40. The pair of apertures 41a are located on respective sides of the center axis C1 at a distance from each other in the second direction Y of the base plate 38. Similarly, a pair of apertures 41b are located on respective sides of the center axis C1 at a distance from each other in the second direction Y of the load beam 40. With this configuration, the pair of apertures 41a and the pair of apertures 41b are located to overlap each other, respectively. In the two overlapping apertures 41a and 41b, first piezoelectric elements (PZT element) 50A, which will be described later, are disposed, respectively.

The head suspension assemblies 30 each include a slender strip-shaped flexure (wiring member) 42 for transmitting recording, reproduction, and drive signals. The distal end-side portion 42a of the flexure 42 is attached onto the first surface S1 of the suspension 34. The proximal side portion (extending portion) 42b of the flexure 42 extends outward from the side edge of the base plate 38 and extends along the side edge of the arm 32 (see FIG. 2). The connection end portion 42c located at the tip of the proximal side portion 42b is connected to the joint portion 21c of the FPC unit 21 described above.

The tip of the flexure 42 is located on the distal end portion of the load beam 40 so as to form a gimbal portion 45 that functions as an elastic support portion. The magnetic head 17 is placed and fixed on the gimbal portion 36 and is supported by the load beam 40 via this gimbal portion 45. A pair of second piezoelectric elements 50B are attached to the gimbal portion 45 and are located at a proximal end portion side of the load beam 40 with respect to the magnetic head 17.

The flexure 42 includes a thin metal sheet (metal plate) 44a of stainless or the like as a base and a strip-shaped stacked multilayered member 44b attached or fixed to the metal sheet 44a, which form a slender stacked multilayered plate. The stacked multilayered member 44b includes a base insulating layer, most of which is fixed to the metal thin plate 44a, a conductive layer (wiring pattern) formed on the base insulating layer and constituting multiple signal wiring lines and drive wiring lines, and a cover insulating layer stacked on the base insulating layer to cover the conductive layer. In the distal end-side portion 42a of the flexure 42, the metal thin plate 44a side is attached onto the surface of the load beam 40 and base plate 38, or spot-welded at multiple weld points.

In the gimbal portion 45, the metal thin plate 44a includes a rectangular-shaped tongue portion (support portion) 45a located on the tip side and a pair of slender outriggers (link portions) 45b extending from the tongue portion 45a to the distal end portion. The tongue portion 45a is formed to have a size and shape on which a magnetic head 17 can be mounted, that is, for example, approximately rectangular. Further, the stacked multilayered member 44b has a tip portion 44c attached onto the tongue portion 45a.

The tongue portion 45a abuts against a dimple (protrusion) not shown in the figure, a substantially central portion of which protrudes from the tip portion of the load beam 40. The tongue portion 45a can be displaced in various directions using the dimple as a fulcrum as the pair of outriggers 45b elastically deform. With this configuration, the tongue portion 45a and the tip portion 44c and the magnetic head 17 mounted on the tongue portion 45a can flexibly follow the surface fluctuations of the magnetic disk 18 in the roll and pitch directions, and thus a minute gap can be maintained between the surface of the magnetic disk 18 and the respective magnetic head 17.

The magnetic head 17 includes a substantially rectangular-shaped slider 17a, which is fixed to the tip portion 44c and the tongue portion 45a by an adhesive. The magnetic head 17 is disposed such that its longitudinal center axis is aligned with the center axis C1 of the suspension 34, and further the substantially central portion of the magnetic head 17 is located on the dimple. The recording and reproducing elements of the magnetic head 17 are electrically jointed to the multiple electrode pads PT of the tip portion 44c by solder or electrically conductive adhesive such as silver paste. In this way, the magnetic head 17 is connected to signal wiring lines W of the flexure 42 via the electrode pads PT.

For the pair of second piezoelectric elements 50B, for example, rectangular plate-shaped thin-film piezoelectric elements (PZT elements) are used. The second piezoelectric elements 50B are attached to the tip portion 44c of the flexure 42 using an adhesive or the like. Each of the second piezoelectric elements 50B is electrically connected to the drive wiring lines of the flexure 42. The second piezoelectric elements 50B are each arranged such that its longitudinal direction (extending/contracting direction) is parallel to the longitudinal direction of the load beam 40. The two second piezoelectric elements 50B are arranged in parallel with each other and are offset to the proximal end portion side of the load beam 40 with respect to the magnetic head 17 on respective sides of the magnetic head 17. Note that the arrangement of the second piezoelectric elements 50B is not limited to that described above, but the elements may as well be arranged at an angle to the center axis C1, for example.

Each of the second piezoelectric elements 50B expands and contracts in the first direction X of the suspension 34 when voltage is applied. By driving these two second piezoelectric elements 50B in opposite directions to each other in expansion and contraction, the tongue portion 45a can be oscillated and the magnetic head 17 can be displaced. As described, the second piezoelectric elements 50B each constitute a second micro-actuator for fine adjustment of the magnetic head 17.

Next, the arrangement of the first piezoelectric elements 50A will be explained in detail.

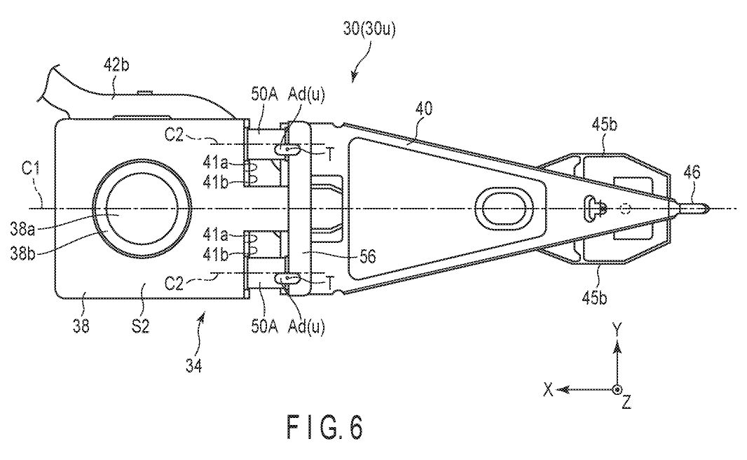

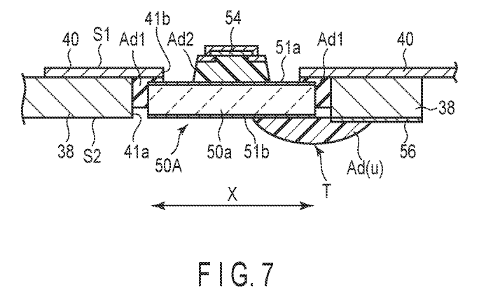

FIG. 6 is a plan view showing a rear surface (second surface) side opposite to the magnetic head of the up-head suspension assembly, and FIG. 7 is a cross-sectional view of the piezoelectric element portion taken along line A-A of FIG. 5.

As shown in FIGS. 6 and 7, for the pair of first piezoelectric elements 50A, for example, rectangular plate-shaped thin-film piezoelectric elements (PZT element) are used. In one example, the first piezoelectric elements 50A each includes a piezoelectric body 50a formed into a flat rectangular parallelepiped shape from a piezoelectric material, and a first electrode 51a and a second electrode 51b provided on the outer surface of the piezoelectric body 50a. As the piezoelectric material, for example, zinc zirconate titanate and ceramics are used.

The first electrode 51a is provided from one end of the upper surface of the piezoelectric body 50a to the side surface on the short edge thereof and over most of the upper surface. The second electrode 51b is provided from one end of the lower surface of the piezoelectric body 50a to the side surface on the other short edge and over most of the lower surface. In one example, the first electrode 51a is referred to as a voltage application (VIN) side electrode, and the second electrode 51b is referred to as a ground (GND) side electrode.

The pair of first piezoelectric elements 50A are arranged in the apertures 41a and 41b of the suspension 34, respectively. Each of the first piezoelectric elements 50A is arranged in such a direction that the longitudinal element center axis C2 is approximately parallel to the center axis C1 of the suspension 34. The pair of first piezoelectric elements 50A are arranged on respective sides of the center axis C1 at a distance from each other in the second direction Y. The distance from the element center axis C2 of one first piezoelectric element 50A to the center axis C1 and the distance from the element center axis C2 of the other first piezoelectric element 50A of the pair to the center axis C1 are set to be equal to each other.

As shown in FIG. 7, the axial one end and the other end the first piezoelectric element 50A are fixed to the base plate 38 and the load beam 40 by a nonconductive adhesive Ad1 within the apertures 41a and 41b, respectively. The first electrode 51a of the first piezoelectric element 50A is exposed upward through the apertures 41a and 41b. The second electrode 51b is also exposed downward through apertures 41a and 41b and is located to be substantially flush with the second surface S2 of the suspension 34.

As shown in FIGS. 5 and 7, to the first electrode 51a, an electrode pad 54 is attached by a conductive adhesive Ad2. The electrode pad 54 is linked to the drive signal lines W of the flexure 42. With this configuration, the first piezoelectric element 50A is electrically connected to the drive signal lines W of the flexure 42.

As shown in FIGS. 6 and 7, a plating layer 56 is formed on the distal end portion of the base plate 38, on the second surface S2. For the plating layer 56, for example, a gold plate is used. The plating layer 56 is installed between the tip of the base plate 38 and a pair of apertures 41a, and extends over the entire width thereof in the second direction Y.

The second electrode 51b of the first piezoelectric element 50A and the plating layer 56 are electrically bonded by the conductive adhesive Ad(u). The conductive adhesive Ad(u) is dropped on the boundary between the second electrode 51b and the plating layer 56 on the second surface S2 of the suspension 34, and is applied over the second electrode 51b and the plating layer 56. The conductive adhesive Ad(u) forms an arc shape having a peak position (top T) in height at approximately the center in the first direction X and the second direction Y. With this configuration, the second electrode 51b is electrically bonded to the plating layer 56 and the base plate 38 by the conductive adhesive Ad(u), and is connected to the ground (G) via the base plate 38.

When a voltage is applied between the first electrode 51a and the second electrode 51b, the piezoelectric body 50a sandwiched between the first electrode 51a and the second electrode 51b elongates or contracts in the longitudinal direction (first direction X). Here, by driving the two first piezoelectric elements 50A in opposite directions in expansion and contraction, it is possible to oscillate the load beam 40 and displace the magnetic head 17. As described, a pair of first piezoelectric elements 50A constitute a first micro-actuator that finely displaces the magnetic head 17.

As shown in FIG. 6, in plan view, the conductive adhesive Ad(u) has an approximately elliptical outline shape. At least one of the pair of conductive adhesives Ad(u) is provided at a position offset in the planar direction, for example, in the second direction Y, with respect to the element center axis C2 of the first piezoelectric element 50A. In more detail, the conductive adhesive Ad(u) is placed such that the top T is offset in the second direction Y with respect to the element center axis C2.

In this embodiment, both of the pair of conductive adhesives Ad(u) are located offset in the second direction Y with respect to the element center axis C2. The pair of conductive adhesives Ad(u) are offset in the same direction, and in this case, they are offset in the direction away from the proximal side portion (extending portion) 42b of the flexure 42 in the second direction Y. The amount of offset can be set arbitrarily. In the example shown in the figure, the periphery of the conductive adhesive Ad(u) is displaced to a position where it us brought into contact with the element center axis C2. The direction of displacement may as well be in an opposite direction to that shown in the figure, that is, in the direction approaching the proximal side portion 42b. Further, the displacement direction is not limited to the second direction Y, but may be in any direction that intersects the center axis C1 in the planar direction.

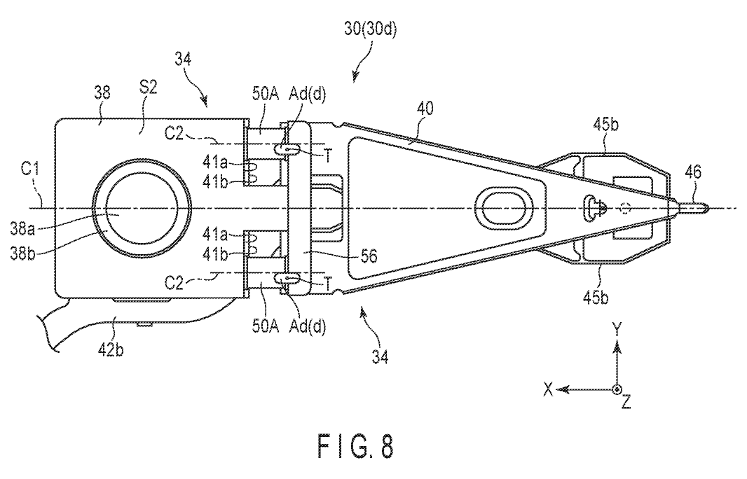

FIG. 8 is a plan view showing a rear surface (second surface S2) side opposite to the magnetic head of the down-head suspension assembly.

As shown in FIG. 8, the down-head suspension assembly 30d is configured to be identical to the up-head suspension assembly 30u described above, except for the following points. That is, in the down-head suspension assembly 30d, the proximal side portion 42b of the flexure 42 extends in the direction opposite to that of the up-head suspension assembly 30u. Further, at least one of the conductive adhesives Ad(d) of the pair of first piezoelectric elements 50A is provided at a position offset in the planar direction, for example, in the second direction Y, with respect to the element center axis C2 of the first piezoelectric element 50A. In more detail, the conductive adhesives Ad(d) are arranged such that the top T is offset in the second direction Y with respect to the element center axis C2.

In this embodiment, both of the pair of conductive adhesives Ad(d) are placed to be offset in the second direction Y with respect to the element center axis C2. The pair of conductive adhesives Ad(d) are offset in the same direction, and here, they are offset in the direction opposite to that of the conductive adhesive Ad(u) of the up-head suspension assembly 30u described above in the second direction Y, that is, in the direction approaching the proximal side portion (extending portion) 42b of the flexure 42.

The amount of displacement can be set arbitrarily. In the example shown in the figure, the periphery of the conductive adhesive Ad(d) is displaced to a position where it is brought into contact with the element center axis C2. The direction of displacement should preferably be opposite to the direction of displacement of the conductive adhesive Ad(u) of the up-head suspension assembly 30u. Note that when the conductive adhesive Ad(u) opposing the up-head suspension assembly 30u is displaced from the element center axis C2, the conductive adhesive Ad(d) opposing the down-head suspension assembly 30d may be disposed on the element center axis C2.

As shown in FIG. 3, the up-head suspension assembly 30u configured as described above is attached to the respective arm 32 in such a state that the second surface S2 side of the base plate 38 is fixed by caulking to the first seating surface 33a of the arm 32. The down-head suspension assembly 30d is attached to the respective arm 32 in such a state that the second surface S2 side of the base plate 38 is fixed by caulking to the second seating surface 33b of the arm 32. With this configuration, the second surface S2 (the surface on an opposite side to the magnetic head 17) of the up-head suspension assembly 30u and the second surface S2 of the down-head suspension assembly 30d now oppose each other with a distance therebetween in the third direction Z. Further, the conductive adhesive Ad(u) of the up-head suspension assembly 30u opposes the conductive adhesive Ad(d) of the down-head suspension assembly 30d in the third direction.

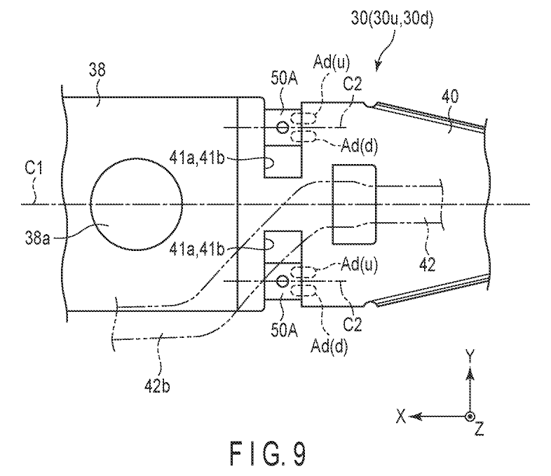

FIG. 9 is a plan view schematically showing the up-head suspension assembly and down-head suspension assembly in a stacked arrangement.

As described above, the pair of conductive adhesives Ad(u) of the up-head suspension assembly 30u are offset in one direction of the second direction Y with respect to the element center axis C2 of the first piezoelectric element 50A. Further, the pair of conductive adhesives Ad(d) of the down-head suspension assembly 30d are offset in the opposite direction of the second direction Y with respect to the center axis C2 of the first piezoelectric element 50A. In this way, as shown in FIG. 9, when the up-head suspension assembly 30u and the down-head suspension assembly 30d are opposing each other, the conductive adhesives Ad(d) and Ad(u) are placed offset in the planar direction, here in the second direction Y with respect to each other without perfectly opposing each other.

Therefore, when attaching the head suspension assembly 30 to the respective arm 32 or when the head suspension assembly 30 is elastically deformed, the possibility of the conductive adhesives Ad(d) and Ad(u) coming into contact or interfering with each other is greatly reduced. Therefore, it is possible to suppress the occurrence of damage to the conductive adhesive and poor connection of the piezoelectric element, and to improve the reliability of the actuator assembly and the HDD.

According to the first embodiment configured as described above, it is possible to provide an actuator assembly and a magnetic disk device with improved reliability by preventing interference and contact of the conductive adhesive.

Note that in the first embodiment described above, the arrangement and amounts of offset of the conductive adhesives Ad(d) and Ad(u) are such as those that they do not overlap in the third direction Z, but they are not limited to such a condition. For example, the adhesives may partially overlap each other in the third direction Z as long as the tops T do not face each other. In other words, when the tops T are offset from each other in the second direction, advantageous effects similar to those of the first embodiment described above can be obtained.

Next, the head suspension assemblies of the HDD according to other embodiments will be described. In the other embodiments described below, the same reference symbols are used for the same parts as in the first embodiment described above, and the detailed descriptions therefor is omitted or simplified. The parts that differ from those of the first embodiment will be mainly explained in detail.

### Second Embodiment

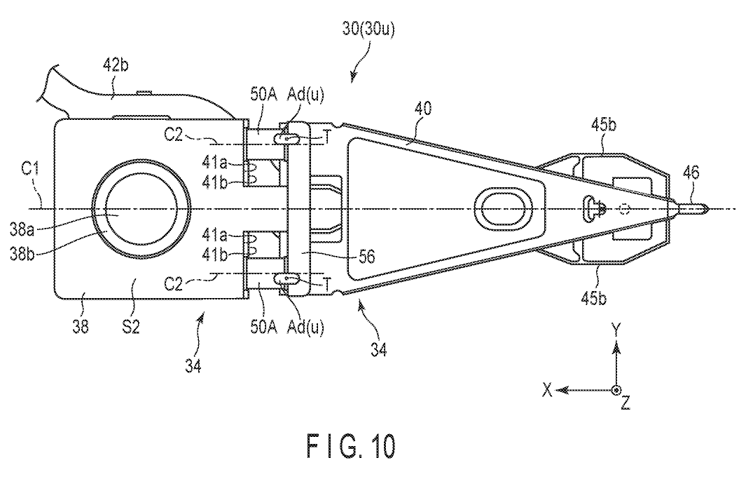

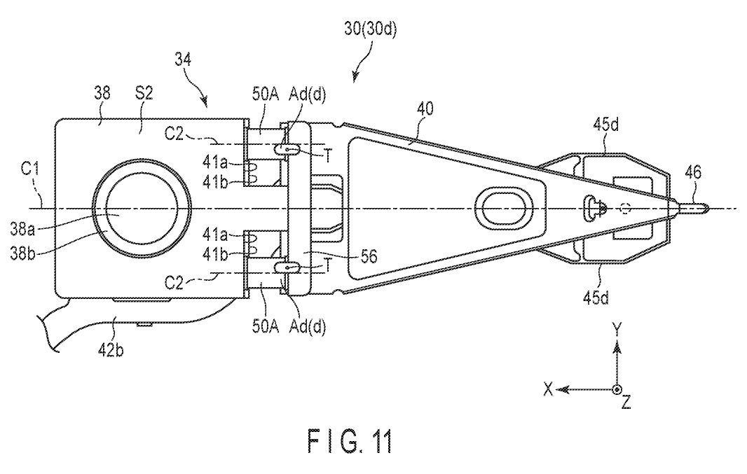

FIG. 10 is a plan view showing a side of an opposite surface (rear surface) to the magnetic head of the up-head suspension assembly of an HDD according to the second embodiment, and FIG. 11 is a plan view showing a side of an opposite surface (rear surface) to the magnetic head of the down-head suspension assembly of the HDD according of the second embodiment

In the second embodiment, the arrangement position of the conductive adhesive Ad that connects the first piezoelectric element 50A to the ground is different from the arrangement position in the first embodiment. In the second embodiment, the other configuration of the head suspension assembly 30 is the same as that of the head suspension assembly 30 in the first embodiment.

As shown in FIG. 10, according to the second embodiment, a pair of conductive adhesives Ad(u) of the up-head suspension assembly 30u are arranged to be offset in opposite directions in the second direction Y with respect to the element center axis C2 of the first piezoelectric element 50A. In more detail, the pair of conductive adhesives Ad(u) are each arranged such that the top T is displaced in a direction away from the center axis C1 of the suspension 34 with respect to the element center axis C2. The amount of displacement can be set arbitrarily. In the example shown in the figure, the periphery of the conductive adhesive Ad(u) is displaced to a position where it is brought into contact with the element center axis C2.

As shown in FIG. 11, in the down-head suspension assembly 30d, a pair of conductive adhesives Ad(d) are arranged to be offset in opposite directions to each other in the second direction Y with respect to the element center axis C2 of the first piezoelectric element 50A, and further in a direction opposite to the offset direction of the conductive adhesive Ad(u) of the up-head suspension assembly 30u. In more detail, the pair of conductive adhesives Ad(d) are arranged such that the top T of each is displaced in a direction that approaches the center axis C1 of the suspension 34 with respect to the element center axis C2. The amount of displacement can be set arbitrarily. In the example shown, the periphery of the conductive adhesive Ad(d) is displaced to a position where it is brought into contact with the element center axis C2.

According to the second embodiment described above, when the up-head suspension assembly 30u and the down-head suspension assembly 30d are opposing each other, the conductive adhesive Ad(d) and conductive adhesive Ad(u) are placed offset in the planar direction, here in the second direction Y with respect to each other without perfectly opposing each other. Therefore, when attaching the head suspension assembly 30 to the respective arm 32 or when the head suspension assembly 30 is elastically deformed, the possibility of the conductive adhesives Ad(d) and Ad(u) coming into contact or interfering with each other is greatly reduced. Therefore, it is possible to suppress the occurrence of damage to the conductive adhesive and poor connection of the piezoelectric element, and to improve the reliability of the actuator assembly and the HDD.

### Third Embodiment

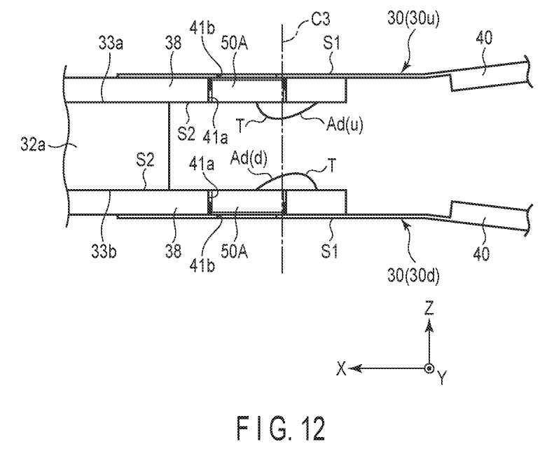

FIG. 12 is a side view showing a part of a head actuator assembly in an HDD according to the third embodiment.

As shown in the figure, according to the third embodiment, the conductive adhesives Ad(u) of the up-head suspension assembly 30u and the conductive adhesives Ad(d) of the down-head suspension assembly 30d are each provided on the element center axis C2 of the first piezoelectric element 50A.

When the center of conductive adhesive Ad(u) and the center of conductive adhesive Ad(d) are defined as a center axis C3, the conductive adhesive Ad(u) is formed and arranged so that its top T is offset in the first direction X with respect to the center axis C3. In one example, the top T is offset in the planar direction approaching the distal end portion 32a of the arm.

The conductive adhesive Ad(d) is formed and arranged so that its top T is offset in the first direction X with respect to the center axis C3. In one example, the top T is offset in the direction away from the distal end portion 32a of the arm, that is, in the direction opposite to the offset direction of the top T of the conductive adhesive Ad(u).

As described above, the top T of the conductive adhesive Ad(u) and the top T of the conductive adhesive Ad(d) are located to be offset in the planar direction, here, in the first direction X, from each other without overlapping in the third direction Z. With this configuration, when attaching the head suspension assembly 30 to the respective arm 32 or when the head suspension assembly 30 is elastically deformed, the possibility of the conductive adhesives Ad(d) and Ad(u) coming into contact or interfering with each other is greatly reduced. Therefore, it is possible to suppress the occurrence of damage to the conductive adhesive and poor connection of the piezoelectric element, and to improve the reliability of the actuator assembly and the HDD.

Note that in the third embodiment, the amount of displacement of the top T of the conductive adhesive Ad can be set arbitrarily. Further, the condition is not limited to both of the conductive adhesives Ad (u) and Ad (d), but it is sufficient if the top of at least one of the conductive adhesives is displaced in the planar direction with respect to the center axis C3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the head suspension assembly, the second piezoelectric element (second micro actuator) may be omitted. The offset directions of the conductive adhesives Ad(u) and Ad(d) are not limited to the first direction X and the second direction Y, and can be set to any other directions. Further, the number of magnetic disks to be installed is not limited to ten, and can be increased up to eleven or twelve.

What is claimed is:

1. An actuator assembly comprising:
a first head suspension assembly comprising a suspension including a first surface, a second surface on an opposite side and a center axis, a wiring member and a magnetic head which are mounted on the first surface of the suspension, and a piezoelectric element mounted on the suspension and bonded to the suspension by a first conductive adhesive applied to a side of the second surface; and
a second head suspension assembly comprising a suspension including a first surface, a second surface on an opposite side, and a center axis, a wiring member and a magnetic head mounted on the first surface of the suspension, and a piezoelectric element mounted on the suspension and bonded to the suspension by a second conductive adhesive applied to a side of the second surface,
wherein
the first head suspension assembly and the second head suspension assembly are arranged in such a manner that the second surfaces of the suspensions oppose each other and the piezoelectric elements oppose each other, and a top portion of the first conductive adhesive is located to be offset in a planar direction of the suspension with respect to a top portion of the second conductive adhesive.

2. The actuator assembly of claim 1, further comprising an arm including a first seating surface and a second seating surface opposing the first seating surface,
wherein
a part of the second surface of the suspension of the first head suspension assembly is fixed to the first seating surface, and a part of the second surface of the suspension of the second head suspension assembly is fixed to the second seating surface.

3. The actuator assembly of claim 1, wherein
each of the piezoelectric elements has an element center axis that extends alongside a center line of the suspension,
the top portion of the first conductive adhesive is displaced in a direction away from the center axis of the suspension with respect to the element center axis, and
the top portion of the second conductive adhesive is displaced in a direction approaching the center axis of the suspension with respect to the element center axis.

4. The actuator assembly of claim 1, wherein
each of the piezoelectric elements has an element center axis that extends alongside a center axis of the suspension,
the first conductive adhesive is displaced in a direction approaching the center axis of the suspension with respect to the element center axis, and
the second conductive adhesive is displaced in a direction away from the center axis of the suspension with respect to the element center axis.

5. The actuator assembly of claim 1, wherein
each of the piezoelectric elements has a center axis of the element that extends alongside the center axis of the suspension, and
a top portion of the first conductive adhesive is located on the element center axis, and
a top portion of the second conductive adhesive is located on the element center axis, and is offset in a direction along the element center axis with respect to the top portion of the first conductive adhesive.

6. The actuator assembly of claim 2, wherein
each of the suspensions includes a base plate fixed to a seating surface of the arm and a load beam extending from the base plate,
the first head suspension assembly includes a pair of piezoelectric elements each provided between the base plate and the load beam, and each piezoelectric element is bonded to the suspension by a first conductive adhesive applied to the side of the second surface,
the second head suspension assembly includes a pair of piezoelectric elements each provided between the base plate and the load beam, and each piezoelectric element is bonded to the suspension by a second conductive adhesive applied to the side of the second surface, and
the pair of piezoelectric elements are arranged to oppose each other, and a top portion of the first conductive adhesive is located to be offset in a planar direction of the suspension with respect to a top portion of the second conductive adhesive.

7. The actuator assembly of claim 6, wherein
the pair of piezoelectric elements each include an element center axis extending alongside a center axis of the suspension, and are arranged while interposing the center axis therebetween to be apart at equal intervals on respective sides of the center axis.

8. The actuator assembly of claim 7, wherein
the pair of first conductive adhesives are each located to be offset in a first direction that intersects a center axis of the suspension with respect to the element center axis, and
the pair of second conductive adhesives are each located to be offset in a second direction opposite to the first direction with respect to the element center axis.

9. The actuator assembly of claim 7, wherein
the pair of first conductive adhesives are each located to be offset in a direction away from a center axis of the suspension with respect to the element center axis, and
the pair of said second conductive adhesives are each located to be offset in a direction approaching the center axis of the suspension with respect to the element center axis.

10. A magnetic disk device comprising:
a plurality of rotatable disk-shaped magnetic recording media; and
an actuator assembly according to claim 1.

11. The magnetic disk device of claim 10, further comprising an arm including a first seating surface and a second seating surface opposing the first seating surface, wherein
a part of the second surface of the suspension of the first head suspension assembly is fixed to the first seating surface, and a part of the second surface of the suspension of the second head suspension assembly is fixed to the second seating surface.

12. The magnetic disk device of claim 10, wherein
each of the piezoelectric elements has an element center axis that extends alongside a center line of the suspension,
the top portion of the first conductive adhesive is displaced in a direction away from the center axis of the suspension with respect to the element center axis, and
the top portion of the second conductive adhesive is displaced in a direction approaching the center axis of the suspension with respect to the element center axis.

13. The magnetic disk device of claim 10, wherein
each of the piezoelectric elements has an element center axis that extends alongside a center axis of the suspension,
the first conductive adhesive is displaced in a direction approaching the center axis of the suspension with respect to the element center axis, and
the second conductive adhesive is displaced in a direction away from the center axis of the suspension with respect to the element center axis.

14. The magnetic disk device of claim 10, wherein
each of the piezoelectric elements has a center axis of the element that extends alongside the center axis of the suspension, and
a top portion of the first conductive adhesive is located on the element center axis, and
a top portion of the second conductive adhesive is located on the element center axis, and is offset in a direction along the element center axis with respect to the top portion of the first conductive adhesive.
